(19) United States
(12) Patent Application Publication
(10) Pub. No.: US 2025/0031199 A1
(43) Pub. Date: Jan. 23, 2025

(54) SMALL DATA TRANSMISSION CONFIGURATION FOR NON-TERRESTRIAL NETWORK

(71) Applicant: QUALCOMM Incorporated, San Diego, CA (US)

(72) Inventors: Changhwan PARK, San Diego, CA (US); Hyunwoo CHO, San Diego, CA (US); Ruiming ZHENG, Beijing (CN); Jing LEI, San Diego, CA (US); Carlos CABRERA MERCADER, Cardiff, CA (US); Xiao Feng WANG, San Diego, CA (US); Liangping MA, San Diego, CA (US)

(21) Appl. No.: 18/714,825

(22) PCT Filed: Oct. 12, 2022
(86) PCT No.: PCT/CN2022/124772

§ 371 Date: May 30, 2024

(30) Foreign Application Priority Data
Feb. 10, 2022 (WO) PCTCN2022075756

(51) Int. Cl. H04W 72/115; H04W 56/00

(52) U.S. Cl. CPC H04W 72/115; H04W 56/0045

(57) ABSTRACT

Various aspects of the present disclosure generally relate to wireless communication. In some aspects, a user equipment (UE) may receive a UE-specific configured grant (CG) small data transmission (SDT) configuration with parameters specific to CG-SDT in a non-terrestrial network (NTN). The UE may receive system information associated with validation of the parameters for CG-SDT on the NTN. The UE may transmit an SDT to a network entity of the NTN using one or more of the parameters. Numerous other aspects are described.

### CROSS-REFERENCE TO RELATED APPLICATION

This Patent Application claims priority to PCT Patent Application No. PCT/CN2022/075756, filed on Feb. 10, 2022, entitled “SMALL DATA TRANSMISSION CONFIGURATION FOR NON-TERRESTRIAL NETWORK,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for using a small data transmission configuration for a non-terrestrial network.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a UE-specific configured grant (CG) small data transmission (SDT) configuration with parameters specific to CG-SDT in a non-terrestrial network (NTN). The method may include receiving system information associated with validation of the parameters for CG-SDT on the NTN. The method may include transmitting an SDT to a network entity of the NTN using one or more of the parameters.

Some aspects described herein relate to a method of wireless communication performed by a network entity of an NTN. The method may include transmitting a UE-specific CG-SDT configuration with parameters specific to CG-SDT in the NTN. The method may include transmitting system information associated with validation of the parameters for CG-SDT on the NTN. The method may include receiving an SDT based at least in part on one or more of the parameters.

Some aspects described herein relate to a UE for wireless communication. The UE may include a memory and one or more processors coupled to the memory. The one or more processors may be configured to receive a UE-specific CG-SDT configuration with parameters specific to CG-SDT in an NTN. The one or more processors may be configured to receive system information associated with validation of the parameters for CG-SDT on the NTN. The one or more processors may be configured to transmit an SDT to a network entity of the NTN using one or more of the parameters.

Some aspects described herein relate to a network entity for wireless communication. The network entity may include a memory and one or more processors coupled to the memory. The one or more processors may be configured to transmit a UE-specific CG-SDT configuration with parameters specific to CG-SDT in the NTN. The one or more processors may be configured to transmit system information associated with validation of the parameters for CG-SDT on the NTN. The one or more processors may be configured to receive an SDT based at least in part on one or more of the parameters.

Some aspects described herein relate to a non-transitory computer-readable medium that stores a set of instructions for wireless communication by a UE. The set of instructions, when executed by one or more processors of the UE, may cause the UE to receive a UE-specific CG-SDT configuration with parameters specific to CG-SDT in an NTN. The set of instructions, when executed by one or more processors of the UE, may cause the UE to receive system information associated with validation of the parameters for CG-SDT on the NTN. The set of instructions, when executed by one or more processors of the UE, may cause the UE to transmit an SDT to a network entity of the NTN using one or more of the parameters.

Some aspects described herein relate to a non-transitory computer-readable medium that stores a set of instructions for wireless communication by a network entity. The set of instructions, when executed by one or more processors of the network entity, may cause the network entity to transmit a UE-specific CG-SDT configuration with parameters specific to CG-SDT in the NTN. The set of instructions, when executed by one or more processors of the network entity, may cause the network entity to transmit system information associated with validation of the parameters for CG-SDT on the NTN. The set of instructions, when executed by one or more processors of the network entity, may cause the network entity to receive an SDT based at least in part on one or more of the parameters.

Some aspects described herein relate to an apparatus for wireless communication. The apparatus may include means for receiving a UE-specific CG-SDT configuration with parameters specific to CG-SDT in an NTN. The apparatus may include means for receiving system information associated with validation of the parameters for CG-SDT on the NTN. The apparatus may include means for transmitting an SDT to a network entity of the NTN using one or more of the parameters.

Some aspects described herein relate to an apparatus for wireless communication. The apparatus may include means for transmitting a UE-specific CG-SDT configuration with parameters specific to CG-SDT in the NTN. The apparatus may include means for transmitting system information associated with validation of the parameters for CG-SDT on the NTN. The apparatus may include means for receiving an SDT based at least in part on one or more of the parameters.

Aspects generally include a method, apparatus, system, computer program product, non-transitory computer-readable medium, UE, base station, network entity, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network entity in communication with a user equipment (UE) in a wireless network, in accordance with the present disclosure.

FIG. 3 is a diagram illustrating an example of a disaggregated base station, in accordance with the present disclosure.

FIG. 4 is a diagram illustrating an example of a regenerative satellite deployment and an example of a transparent satellite deployment in a non-terrestrial network (NTN), in accordance with the present disclosure.

FIG. 5 is a diagram illustrating an example of transmitting a configured grant small data transmission (CG-SDT) associated with a 4-step random access channel procedure, in accordance with the present disclosure.

FIG. 6 is a diagram illustrating an example of parameters that be included in a CG-SDT configuration, in accordance with the present disclosure.

FIG. 7 illustrates an example of command and activation timing, in accordance with the present disclosure.

FIG. 8 is a diagram illustrating an example of a timeline for providing a configuration and system information, in accordance with the present disclosure.

FIG. 9 is a diagram illustrating an example process performed, for example, by a UE, in accordance with the present disclosure.

FIG. 10 is a diagram illustrating an example process performed, for example, by a network entity, in accordance with the present disclosure.

FIGS. 11-12 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

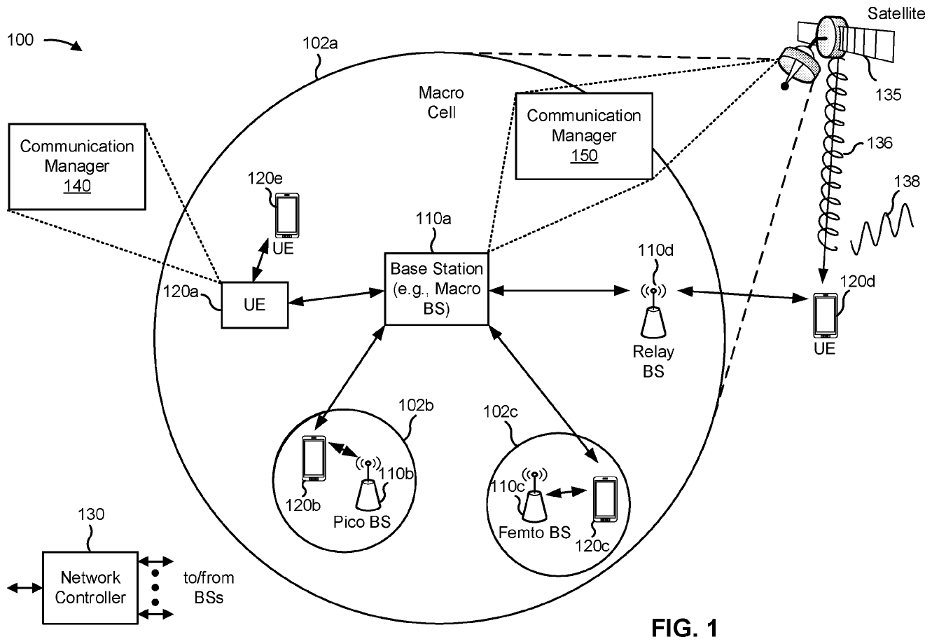

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include a user equipment (UE) 120 or multiple UEs 120 (shown as a UE 120a, a UE 120b, a UE 120c, a UE 120d, and a UE 120e). The wireless network 100 may also include one or more network entities, such as base stations 110 (shown as a BS 110a, a BS 110b, a BS 110c, and a BS 110d), and/or other network entities. A base station 110 is a network entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network entities in the wireless network 100 through various types of backhaul interfaces, such as a direct physical connection or a virtual network, using any suitable transport network.

In some aspects, the term “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

The wireless network 100 may include one or more relay stations. A relay station is a network entity that can receive a transmission of data from an upstream station (e.g., a network entity or a UE 120) and send a transmission of the data to a downstream station (e.g., a UE 120 or a network entity). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network with network entities that include different types of BSs, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set network entities and may provide coordination and control for these network entities. The network controller 130 may communicate with the base stations 110 via a backhaul communication link. The network entities may communicate with one another directly or indirectly via a wireless or wireline backhaul communication link.

In some aspects, as shown, a cell may be provided by a network entity (e.g., base station 110) of a non-terrestrial network (NTN). As used herein, “non-terrestrial network” may refer to a network for which access is provided by a non-terrestrial base station, such as a base station carried by a satellite, a balloon, a dirigible, an airplane, an unmanned aerial vehicle, and/or a high altitude platform station. A network entity in an NTN (NTN network entity) may use a polarization. For example, a network entity in a satellite 135 (NTN network entity) may transmit a communication to the UE 120 using a circular polarization 136 or a linear polarization 138. Circular polarization occurs when the tip of the electric field of an electromagnetic wave at a fixed point in space traces a circle, and the electromagnetic wave may be formed by superposing two orthogonal linearly polarized waves of equal amplitude and a 90-degree phase difference. A circular polarization may be a right-hand circular polarization (RHCP) or a left-hand circular polarization (LHCP). Linear polarization occurs when the tip of the electric field of an electromagnetic wave at a fixed point in space oscillates along a straight line over time.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network entity, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network entity as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a UE-specific configured grant (CG) small data transmission (SDT) configuration with parameters specific to CG-SDT in an NTN. The communication manager 140 may receive system information associated with validation of the parameters for CG-SDT on the NTN and transmit an SDT to a network entity of the NTN using one or more of the parameters. Additionally, or alternatively, the communication manager 140 may perform one or more other operations described herein.

In some aspects, a network entity (e.g., base station 110, satellite 135) may include a communication manager 150. As described in more detail elsewhere herein, the communication manager 150 may transmit a UE-specific CG-SDT configuration with parameters specific to CG-SDT in the NTN. The communication manager 150 may transmit system information associated with validation of the parameters for CG-SDT on the NTN and receive an SDT based at least in part on one or more of the parameters. Additionally, or alternatively, the communication manager 150 may perform one or more other operations described herein.

As indicated above, FIG. 1 is provided as an example. Other examples may differ from what is described with regard to FIG. 1.

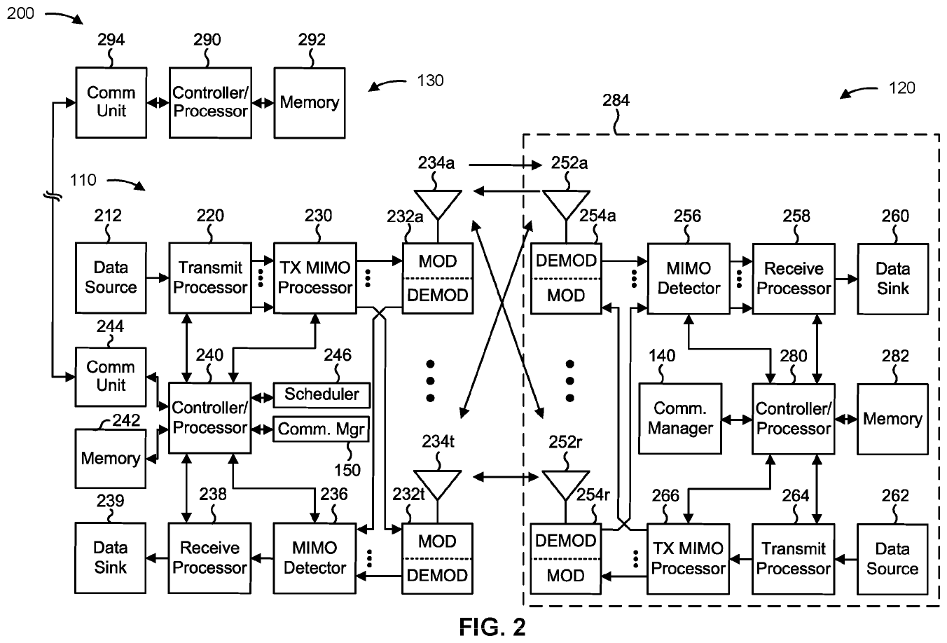

FIG. 2 is a diagram illustrating an example 200 of a network entity (e.g., base station 110) in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). The PSS/SSS may include a PSS/SSS per cell for MTC devices and an NB PSS (NPSS)/NB SSS (NSSS) for NB-IoT devices. A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t. The base station 110 may be an NTN network entity located in a terrestrial location or in a non-terrestrial location (e.g., satellite 135).

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network entity via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

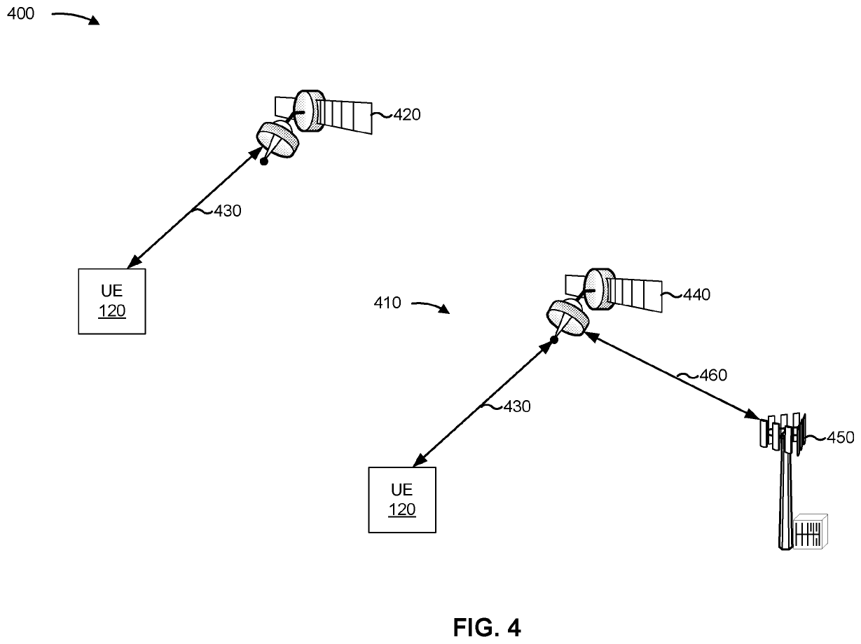

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network entity. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-12).

At the network entity (e.g., base station 110), the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network entity may include a communication unit 244 and may communicate with the network controller 130 via the communication unit 244. The network entity may include a scheduler 246 to schedule one or more UEs 120 for downlink and/or uplink communications. In some examples, the modem 232 of the network entity may include a modulator and a demodulator. In some examples, the network entity includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-12).

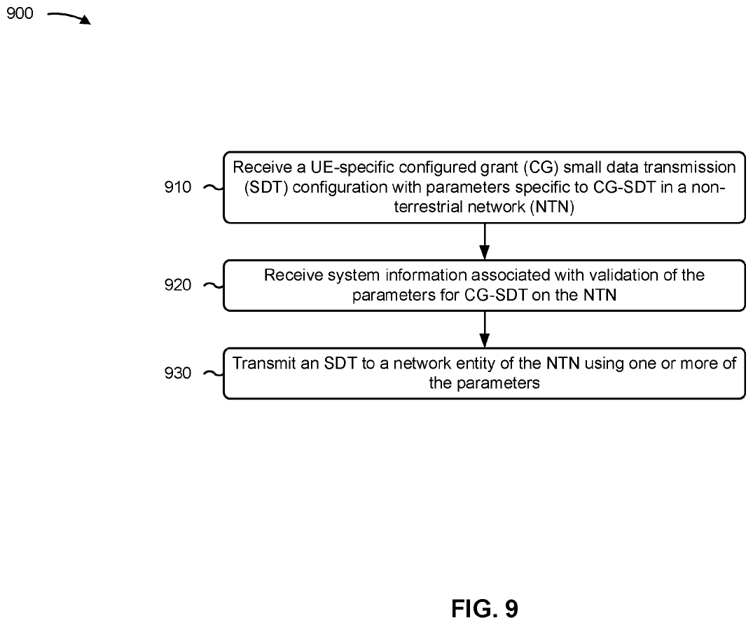

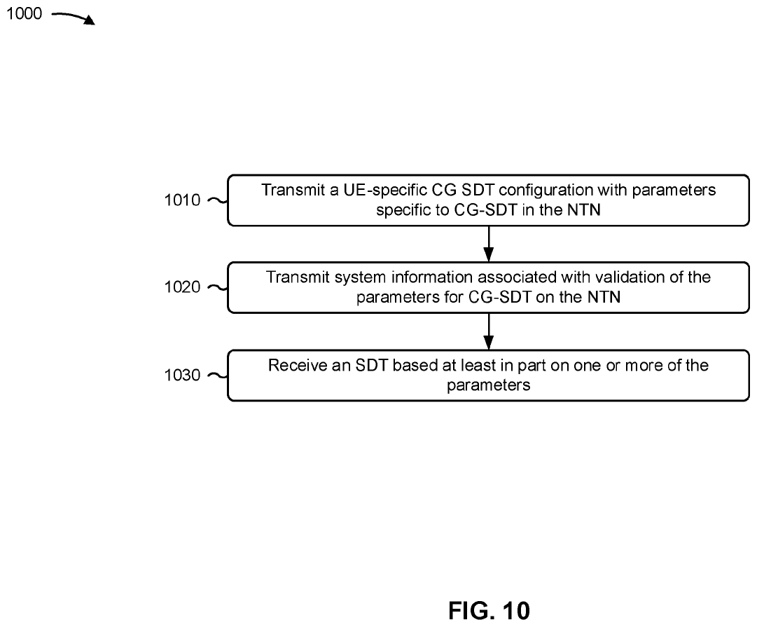

A controller/processor of a network entity, (e.g., the controller/processor 240 of the base station 110), the controller/processor 280 of the UE 120, and/or any other component(s) of FIG. 2 may perform one or more techniques associated with using a configuration for CG-SDT in an NTN, as described in more detail elsewhere herein. In some aspects, the network entity is a network entity at the surface or at a satellite (e.g., 135). For example, the controller/processor 240 of the base station 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the network entity and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network entity and/or the UE 120, may cause the one or more processors, the UE 120, and/or the network entity to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the UE 120 includes means for receiving a UE-specific CG-SDT configuration with parameters specific to CG-SDT in an NTN; means for receiving system information associated with validation of the parameters for CG-SDT on the NTN; and/or means for transmitting an SDT to a network entity of the NTN using one or more of the parameters. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network entity 110 includes means for transmitting a UE-specific CG-SDT configuration with parameters specific to CG-SDT in the NTN; means for transmitting system information associated with validation of the parameters for CG-SDT on the NTN; and/or means for receiving an SDT based at least in part on one or more of the parameters. In some aspects, the means for the network entity 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

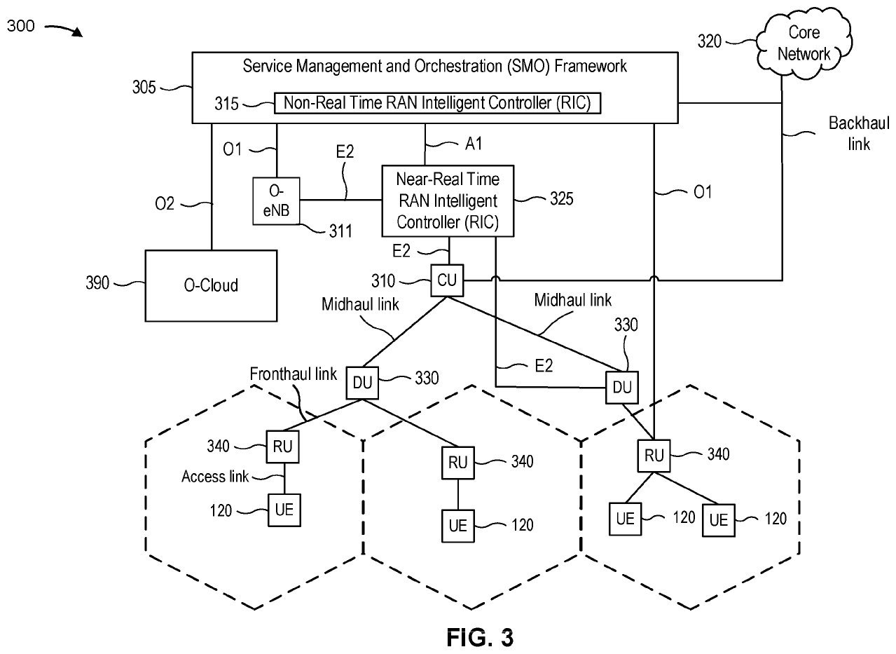

FIG. 3 is a diagram illustrating an example of a disaggregated base station 300, in accordance with the present disclosure.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station, or one or more units (or one or more components) performing base station functionality, may be implemented in an aggregated or disaggregated architecture. For example, a BS (such as a Node B, evolved NB (eNB), NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station 300 architecture may include one or more CUs 310 that can communicate directly with a core network 320 via a backhaul link, or indirectly with the core network 320 through one or more disaggregated base station units (such as a Near-RT RIC 325 via an E2 link, or a Non-Real Time (Non-RT) RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The fronthaul link, the midhaul link, and the backhaul link may be generally referred to as “communication links.” The RUs 340 may communicate with respective UEs 120 via one or more RF access links. In some aspects, the UE 120 may be simultaneously served by multiple RUs 340. The DUs 330 and the RUs 340 may also be referred to as “O-RAN DUs (O-DUs”) and “O-RAN RUs (O-RUs)”, respectively. A network entity may include a CU, a DU, an RU, or any combination of CUs, DUs, and RUs. A network entity may include a disaggregated base station or one or more components of the disaggregated base station, such as a CU, a DU, an RU, or any combination of CUs, DUs, and RUs. A network entity may also include one or more of a TRP, a relay station, a passive device, an intelligent reflective surface (IRS), or other components that may provide a network interface for or serve a UE, mobile station, sensor/actuator, or other wireless device.

Each of the units, i.e., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

FIG. 4 is a diagram illustrating an example 400 of a regenerative satellite deployment and an example 410 of a transparent satellite deployment in an NTN, in accordance with the present disclosure.

Example 400 shows a regenerative satellite deployment. In example 400, a UE 120 is served by a satellite 420 (e.g., satellite 135) via a service link 430. For example, the satellite 420 may include a BS 110 (e.g., BS 110a), and/or a gNB. In some aspects, the satellite 420 may be referred to as a non-terrestrial base station, a regenerative repeater, an on-board processing repeater, and/or an NTN entity. In some aspects, the satellite 420 may demodulate an uplink radio frequency signal, and may modulate a baseband signal derived from the uplink radio signal to produce a downlink radio frequency transmission. The satellite 420 may transmit the downlink radio frequency signal on the service link 430. The satellite 420 may provide a cell that covers the UE 120.

Example 410 shows a transparent satellite deployment, which may also be referred to as a bent-pipe satellite deployment. In example 410, a UE 120 is served by a satellite 440 via the service link 430. The satellite 440 may also be considered to be an NTN entity. The satellite 440 may be a transparent satellite. The satellite 440 may relay a signal received from gateway 450 via a feeder link 460. For example, the satellite may receive an uplink radio frequency transmission, and may transmit a downlink radio frequency transmission without demodulating the uplink radio frequency transmission. In some aspects, the satellite may frequency convert the uplink radio frequency transmission received on the service link 430 to a frequency of the uplink radio frequency transmission on the feeder link 460, and may amplify and/or filter the uplink radio frequency transmission. In some aspects, the UEs 120 shown in example 400 and example 410 may be associated with a Global Navigation Satellite System (GNSS) capability, a Global Positioning System (GPS) capability, and/or the like, though not all UEs have such capabilities. The satellite 440 may provide a cell that covers the UE 120.

The service link 430 may include a link between the satellite 440 and the UE 120, and may include one or more of an uplink or a downlink. The feeder link 460 may include a link between the satellite 440 and the gateway 450, and may include one or more of an uplink (e.g., from the UE 120 to the gateway 450) or a downlink (e.g., from the gateway 450 to the UE 120).

The feeder link 460 and the service link 430 may each experience Doppler effects due to the movement of the satellites 420 and 440, and potentially movement of a UE 120. These Doppler effects may be significantly larger than in a terrestrial network. The Doppler effect on the feeder link 460 may be compensated for to some degree, but may still be associated with some amount of uncompensated frequency error. Furthermore, the gateway 450 may be associated with a residual frequency error, and/or the satellite 420/440 may be associated with an on-board frequency error. These sources of frequency error may cause a received downlink frequency at the UE 120 to drift from a target downlink frequency.

Satellites 420 and 440 may be a satellite in a geostationary orbit (GSO) or geosynchronous equatorial orbit (GEO), which may be, for example, 36,000 km above the earth. The speed of the satellite with respect to earth may be negligible but have a propagation delay of more than 500 milliseconds (ms), as compared to 25 ms for a low earth orbit (LEO) satellite at 600 km above the earth. In an NTN, where a distance between UE 120 and a satellite can be larger than 600 km, a pathloss change may not be appropriately reflected in a propagation delay change. The UE 120 is expected to be able to autonomously pre-compensate for propagation delay all the way to a reference point, and thus timing advance (TA) validation can be carried out more directly rather than relying on indirect parameters such as RSRP. The UE 120 may use a TA for timing alignment of communications due to a propagation delay. The TA may inform the UE 120 transmit a communication earlier than scheduled by the TA amount. The TA may need to be validated if the propagation distance between the UE 120 and the network entity changes. In addition, a satellite may not be always available to the UE 120 if the satellite is in a non-geostationary orbit (NGSO).

As indicated above, FIG. 4 is provided as an example. Other examples may differ from what is described with regard to FIG. 4.

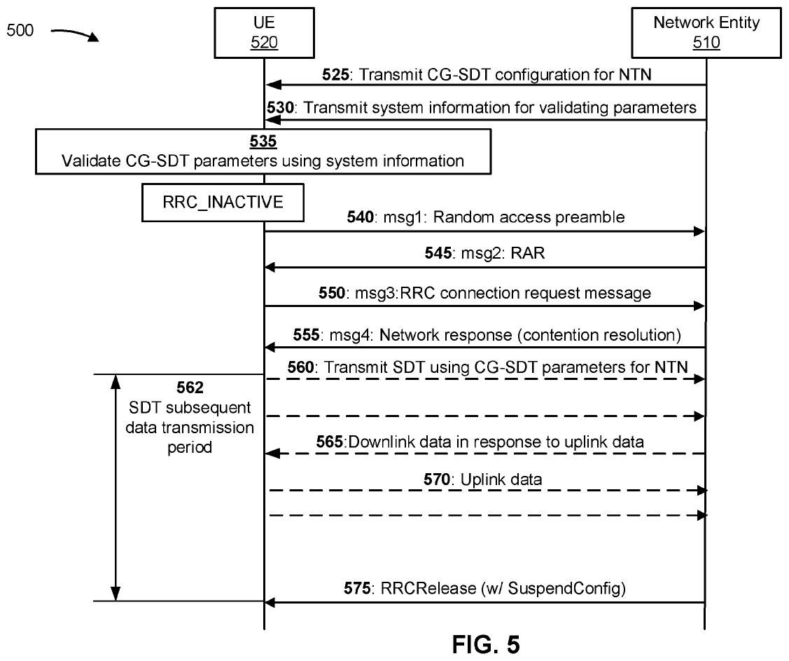

FIG. 5 is a diagram illustrating an example 500 of transmitting a CG-SDT associated with a 4-step random access channel (RACH) procedure, in accordance with the present disclosure. As shown in FIG. 5, a network entity 510 (e.g., base station 110, satellite 420, satellite 440) and a UE 520 (e.g., UE 120) may communicate with one another to transmit SDTs as part of a 4-step RACH procedure on an NTN.

A CG-SDT resource can be made available across cells within a satellite depending on deployments. According to various aspects described herein, the UE 520 may be configured for CG-SDT for an NTN. For example, as shown by reference number 525, the network entity 510 may transmit a CG-SDT configuration for an NTN. The CG-SDT may include parameters such as a MAC application TA Kmac for delaying an application of a downlink configuration indicated by a MAC control element (MAC CE). The duration for Kmac may include a duration between reception of an activation command (e.g., downlink control information (DCI)) by the UE 520 and application of the activation command by the UE 520. The parameters may include a time offset Koffset for delaying a RACH procedure initiated by a physical downlink control channel (PDCCH) communication (e.g., the DCI) and delaying uplink transmission scheduled by CG. This Koffset may be specific to CG-SDT on the NTN. Koffset may be cell common or UE-specific. A CG-SDT may be referred to as a “preconfigured uplink resource (PUR)” in some access networks.

As shown by reference number 530, the network entity 510 may transmit system information for validating the parameters, which are for the NTN. The system information may include, for example, timing relation validation information for validating the MAC TA Kmac and the time offset Koffset.

As shown by reference number 535, the network entity 510 may validate the parameters using the system information. This may include, for example, validating the MAC TA Kmac and the time offset Koffset using the timing relation validation information. Validating may include performing measurements and determining whether the measurements satisfy one or more RSRP thresholds (e.g., minimum RSRP, maximum RSRP). Validating may also include determining whether a measurement is during a time interval or during a timer.

The UE 520 may perform a RACH procedure to establish an RRC connection with the network entity 510. The UE 520 may be in an inactive state, such as an RRC inactive state, to conserve battery power and network resources in times of infrequent data traffic. “Inactive state” may refer to a UE that is operating in an inactive communication mode. To reenter an active state, the UE 520 may perform the RACH procedure. The RACH procedure may involve signaling in 2 steps (2-step RACH procedure) or 4 steps (4-step RACH procedure). As a first step of a 4-step RACH procedure and as shown by reference number 540, the UE 520 may transmit a random access message (RAM), which may include a preamble (sometimes referred to as a random access preamble, a PRACH preamble, or a RAM preamble). The message that includes the preamble may be referred to as a message 1, msg1, MSG1, a first message, or an initial message in a 4-step RACH procedure. The random access message may include a random access preamble identifier.

The network entity 510 may receive the RAM preamble transmitted by the UE 520. If the network entity 510 successfully receives and decodes the RAM preamble, the network entity 510 may then receive and decode the RAM payload. As shown by reference number 545, the network entity 510 may transmit a random access response (RAR) as a reply to the preamble. The message that includes the RAR may be referred to as message 2, msg2, MSG2, or a second message in a 4-step random access procedure. In some aspects, the RAR may indicate the detected random access preamble identifier (e.g., received from UE 520 in msg1). Additionally, or alternatively, the RAR may indicate a resource allocation to be used by the UE 520 to transmit message 3 (msg3).

In some aspects, as part of the second step of the 4-step RACH procedure, the network entity 510 may transmit a PDCCH communication for the RAR. The PDCCH communication (e.g., DCI) may schedule a physical downlink shared channel (PDSCH) communication that includes the RAR. For example, the PDCCH communication may indicate a resource allocation for the PDSCH communication. Also as part of the second step of the 4-step RACH procedure, the network entity 510 may transmit the PDSCH communication for the RAR, as scheduled by the PDCCH communication. The PDCCH may include an MTC PDCCH (MPDCCH) for MTC devices or an NB PDCCH (NPDCCH) for NB-IoT devices. The PDSCH may include an NB PDSCH (NPDSCH) for NB-IoT devices.

As shown by reference number 550, the UE 520 may transmit an RRC connection request message. The RRC connection request message may be referred to as message 3, msg3, MSG3, or a third message of a 4-step RACH procedure. In some aspects, the RRC connection request may include a UE identifier, uplink control information (UCI), and/or a physical uplink shared channel (PUSCH) communication (e.g., an RRC connection request). The PUSCH may include an NB PUSCH (NPUSCH) format 1 for NB-IoT devices. The physical uplink control channel (PUCCH) may include an NPUSCH format 2 for NB-IoT devices. The UE 520 may transition between different modes based at least in part on various commands and/or communications received from the network entity 510, and the UE 520 may transmit an RRC resume request (RRCResumeRequest) in the msg3 to transition from an RRC inactive state to an RRC active state. The RRC resume request may also establish some security for messages from the UE 520 to the network entity 510, by verifying an identity of the UE 520. The UE 520 may include data, such as an SDT, in the msg3 with the RRC resume request. An SDT may be a data that is in smaller amount and that can be transmitted without the UE 520 being fully connected. In many applications, the UE 520 may generate only a small amount of data in a burst of a data session. Examples of such applications include enhanced mobile broadband (eMBB) communications, Internet of Things (IoT) communications, instant messaging applications, social media applications, and/or wearable device applications. The SDT may be configured or scheduled by CG. The UE 520 may establish an SDT PDCP and transmit SDT resource blocks (RBs) that are configured for small data.

Upon arrival of data for data radio bearers (DRBs) or signal radio bearer (SRBs) for which SDT is enabled (i.e., SDT RBs), the criteria for selection between SDT and non-SDT procedure at least includes the UE 520 checking whether available data volume is smaller than data volume threshold, and the UE 520 is to perform carrier selection for SDT if both normal uplink carrier (NUL) and supplemental uplink carrier (SUL) are configured and SDT resources are configured. The UE 520 is to determine whether the RSRP is greater than or equal to a configured RSRP threshold for SDT. The RSRP threshold is used to select between SDT and non-SDT procedure, if configured. The RSRP threshold is also used to select between SDT and non-SDT procedure and used for both CG-SDT and RA-SDT. A data volume threshold (to select between SDT and non-SDT procedure) is the same for CG-SDT and RA-SDT. The RSRP threshold for carrier selection is specific to SDT (i.e. separately configured for SDT). The RSRP threshold for random access (RA) type selection is specific to SDT (i.e. separately configured for SDT).

If the above criteria is considered met, if CG-SDT resources are configured and valid on the selected uplink carrier, and if the UE 520 can find an RSRP of a synchronization signal block (SSB) is above the configured RSRP threshold for CG-SDT criteria, the UE 520 selects CG-SDT and initiates RRC resume for SDT using the selected CG-SDT resource. Otherwise, the UE 520 checks whether RA-SDT resources are configured on the selected UL carrier and valid. This check is similar to the normal RACH resource selection and checking. If the RA-SDT criteria is considered met, the UE 520 selects RA-SDT and performs RA-SDT. The UE 520 is to perform RA type selection using the SDT specific RSRP threshold (e.g., either 4-step RA-SDT or 2-step RA-SDT). Otherwise, the UE 520 may perform a regular RRC resume (i.e., not perform SDT). A physical broadcast channel (PBCH) of an SSB may include a PBCH per cell for MTC devices or an NB PBCH (NPBCH) per cell for NB IoT devices.

For initial CG-SDT transmission, the UE 520 does not select any SSB if none of the SSBs' RSRP is above the RSRP threshold. The UE 520 may select an RA-SDT if the RA-SDT criteria is met.

As shown by reference number 555, the network entity 510 may transmit an RRC connection setup message. The RRC connection setup message may be referred to as message 4, msg4, MSG4, or a fourth message of a 4-step RACH procedure. In some aspects, the RRC connection setup message may include a detected UE identifier, a timing advance value, and/or contention resolution information. In some aspects, if the UE 520 performs a 2-step RACH procedure, the msg1 and the msg3 may be combined into a single message that is referred to as a “msgA,” and the msg2 and the msg4 may be combined into a single message that is referred to as a “msgB.” After completion of the 4-step (or 2-step) RACH procedure, the UE 520 may transmit and receive data.

As shown by reference number 560, the UF 520 may transmit an SDT using the CG-SDT parameters for the NTN. This may be during an SDT subsequent data transmission period 562 that is subsequent to a RACH procedure or a configuration for uplink grants. In the subsequent data transmission (after successful contention resolution), the UE 520 may use a CG to transmit data or monitor for a dynamic grant (DG) by a cell RNTI (C-RNTI) in a separate common search space (CSS) (if configured) in RA-SDT. During the SDT subsequent data transmission period, the network entity 510 may allow the UE 520 to transmit data of the SDT type during an RRC inactive state or an RRC idle state, without requiring the UE 520 to enter an RRC connected state or an RRC active state. The UE 520 may transmit data of the SDT type during the SDT subsequent data transmission period from a buffer, which holds data of the SDT type. The UE 520 may transmit data until the buffer is empty. As shown by reference number 565, the network entity 510 may transmit downlink data in response to the uplink data. As shown by reference number 570, the UE 520 may transmit more uplink data, which may include or may not include SDTs. As shown by reference number 575, an RRCRelease message may be sent at the end to terminate the SDT procedure from an RRC point of view.

The configuration of a CG resource for a UE uplink small data transfer may be included in the RRCRelease message. The RRCRelease message is also used to reconfigure or release the CG-SDT resources while UE is in RRC inactive. The configuration of a CG resource may include a type 1 CG configuration. Multiple CG-SDT configurations per carrier in an RRC inactive state can be supported by network configuration. For CG-SDT, the subsequent data transmission can use the CG resource or DG. The UE 520 may support retransmission by DG for CG-SDT.

During the subsequent new CG transmission phase, for the purpose of CG resource selection, the UE 520 re-evaluates the SSB for subsequent CG transmission. Because there may not be a new UE-specific RNTI for SDT, UE 520 may monitor for PDCCH communications addressed by a C-RNTI in CG-SDT. The C-RNTI may be previously configured in RRC connects. A cell specific RNTI (CS-RNTI)-based dynamic retransmission mechanism can be reused for CG-SDT. UE 520 may start a window after CG/DG transmission for CG-SDT. The UE 520 may support multiple hybrid automatic repeat request (HARQ) processes for uplink CG-SDT. CG-SDT resources can be configured both on NUL and SUL. UL carrier selection is performed before CG-SDT selection. The UE 520 may release CG-SDT resources when SDT TA timer (TAT-SDT) expires in RRC inactive. The UE 520 should release CG-SDT resource (if stored) when the UE 520 initiates RRC resume procedure from another cell which is different from the cell in which the RRCRelease is received.

By providing and validating parameter in a CG-SDT configuration that is specific to an NTN, the UE 520 may transmit SDTs in the NTN. The parameters may improve timing alignment between the UE 520 and the network entity 510 and improve communications. Improved communications conserves processing resources and signaling resources.

As indicated above, FIG. 5 is provided as an example. Other examples may differ from what is described with regard to FIG. 5.

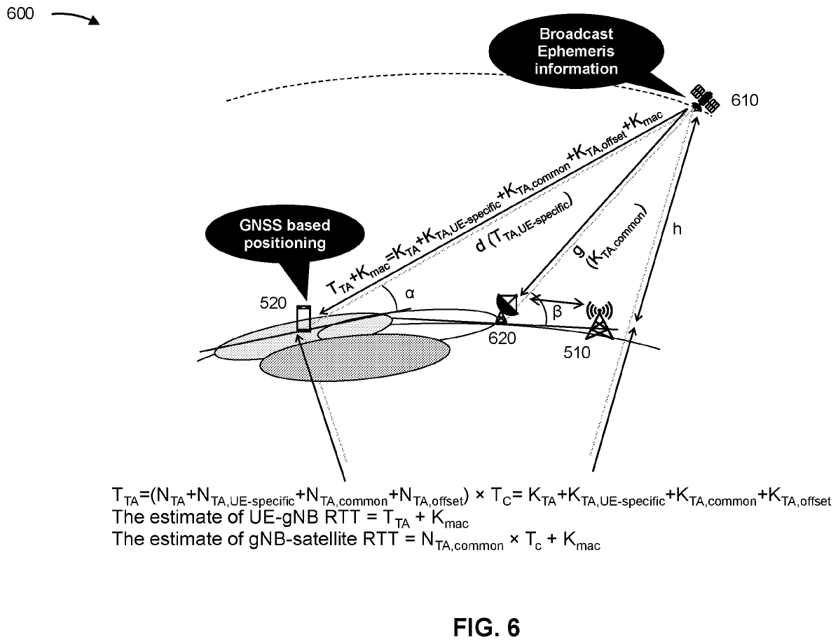

FIG. 6 is a diagram illustrating an example 600 of parameters that may be included in a CG-SDT configuration, in accordance with the present disclosure.

Example 600 shows the UE 520 and an example location of the network entity 510 with respect to a satellite 610 (which may also be network entity 510) and a relay station 620. The satellite 610 may be a distance h above the earth and a distance g from the relay station 620. The network entity 510 and the relay station may be separated by a distance β. The satellite 610 may be at an angle a and a distance d from the UE 520.

As mentioned above, a CG-SDT configuration may include a parameter such as Koffset. Koffset may be configured in system information and used in initial access, in at least a cell-specific Koffset configuration, which is used in all beams of a cell. The UE-specific Koffset can be provided and updated by the network entity 510 with a MAC CE. A MAC CE may provide a differential UE-specific Koffset value. The full UE-specific Koffset value may equal the cell-specific Koffset value minus a differential UE specific Koffset value. When the UE 520 is not provided with a Koffset value other than the one signaled in system information, the Koffset value signaled in system information may be used for all timing relationships that require Koffset enhancement.

The Koffset value signaled in system information may be used for the transmission timing of an RAR or a fallback RAR grant scheduled PUSCH. The Koffset value may be used for transmission timing of Msg3 retransmission scheduled by DCI format 0_0 with CRC scrambled by a temporary cell RNTI (TC-RNTI). The Koffset value may be used for transmission timing of HARQ acknowledgement (HARQ-ACK) on a PUCCH to contention resolution PDSCH scheduled by DCI format 1_0 with CRC scrambled by TC-RNTI. The Koffset value may be used for the transmission timing of HARQ-ACK on PUCCH to MsgB scheduled by DCI format 1_0 with a cyclic redundancy check (CRC) scrambled by a MsgB-RNTI.

The Koffset may be applied to indicate the first transmission opportunity of PUSCH in Configured Grant Type 2 in the same way as Koffset is applied to the transmission timing of a DCI-scheduled PUSCH. The Koffset value signaled in system information may be used for a PDCCH ordered PRACH timing relationship. The unit of Koffset may be a quantity of slots for a given subcarrier spacing. For a random access procedure initiated by a PDCCH order received in a downlink slot, the UE 520 may determine the next available PRACH occasion after an uplink slot that is Koffset after the downlink slots to transmit the ordered PRACH.

With respect to the NTN CG-SDT configuration, in some aspects, CG-SDT parameters may be specific to the NTN and/or in addition to parameters for terrestrial networks. For example, parameters for TA validation may include RSRP thresholds that are specific to the NTN. These RSRP thresholds may be different than RSRP thresholds for a terrestrial network and/or may be in addition to the RSRP threshold for the terrestrial network. NTN-specific parameters may be obtained in a UE-specific manner, a cell-specific manner, or a satellite-specific manner. A Koffset for CG-SDT in an NTN may be used for SDT transmissions and for subsequent transmissions after an initial transmission of a CG-SDT (e.g., PUCCH and PUSCH new transmission or retransmission scheduled by PDCCH in a CG-SDT search space).

There may be several options for Koffset for CG-SDT in an NTN. As a first option, a cell-common Koffset (provided in system information) may be used for subsequent transmissions after an initial transmission of a CG-SDT. As a second option, a Koffset may be UE-specifically configured while the UE 520 is in an RRC connected mode, stored, and used for subsequent transmissions after an initial transmission. As a third option, the UE 520 may be configured with a separate UE-specific Koffset for CG-SDT in an RRC Release message. In any case, the network entity 510 may explicitly reconfigure Koffset in an RRC inactive mode.

Another CG-SDT configuration parameter for an NTN may be Kmac, as mentioned above. The information of Kmac may be carried in system information. The unit of Kmac may be a number of slots for a given subcarrier spacing. The value range of Kmac may be 1-512 ms. When the UE 520 is not provided a Kmac value, the UE 520 may assume that Kmac=0. If the UE 520 is provided with a Kmac value, when the UE 520 would transmit a PUCCH with HARQ-ACK information in uplink slot n corresponding to a PDSCH carrying a MAC CE command at slot x on a downlink configuration, the UE 520 action based on the downlink configuration may be applied starting from the first slot that is after downlink slot n+3Nₛₗₒₜ^{subframe,μ}+K_{mac}, where μ is the subcarrier spacing (SCS) configuration for the PUCCH.

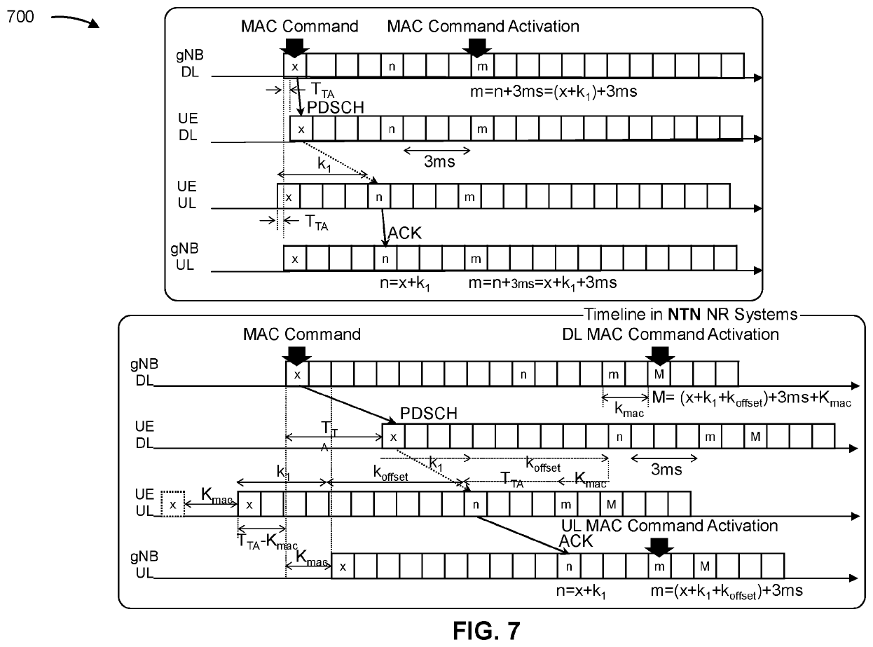

FIG. 7 illustrates an example 700 of command and activation timing, in accordance with the present disclosure. Example 700 shows the MAC command received at slot x, the HARQ-ACK information at slot n, and activation of the MAC command at slot m. Example 700 shows an example of applying Kmac for MAC application timeline alignment between the UE 520 and the network entity 510 in the NTN. This results in activation at slot M. A cell-common Kmac (provided in system information) may be used for CG-SDT transmission and subsequent transmissions.

The Kmac may denote a scheduling offset other than Koffset. If downlink and uplink frame timing are aligned at the gNB, for UE action based on a downlink configuration indicated by a MAC CE command in PDSCH, Kmac may not be needed. For UE action based on an uplink configuration indicated by a MAC CE command in PDSCH, Kmac may not be needed. If downlink and uplink frame timing are not aligned at the gNB, for UE action based on a downlink configuration indicated by a MAC CE command in PDSCH, Kmac may be needed. For UE action based on an uplink configuration indicated by a MAC CE command in PDSCH, Kmac may not be needed. Note that this does not preclude identifying exceptional MAC CE timing relationship(s) that may or may not require Kmac.

The parameters may include or may be related to a TA. The TA may be calculated as TA=(N_{TA}+N_{{TA,UE-specific}}+N_{{TA,common}}+N_{{TA,offset}})×T_{c}. N_{{TA,offset}} may depend on band and LTE/NR coexistence and is specified in 3GPP Technical Specification (TS) 38.213 section 4.2. T_{c} is specified in TS 38.211 section 4.1. N_{{TA,UE-specific}} is UE self-estimated TA to pre-compensate for the service link delay, which is calculated using the UE position and the serving satellite ephemeris. For N_{{TA,offset}}, the UE 520 may use indicated Higher-layer Common TA parameters. If configured, the UE 520 can determine the one-way propagation time (Delay_common) used for N_{{TA,common}} calculation as follows:

$${Delay}_{common} ( t ) = {D}_{C o mmon} ( {t}_{epoch} ) + DCommonDrift \times ( t - {t}_{epoch} ) + DCommonDriftVariation \times {( t - {t}_{epoch} )}^{2} where : {D}_{Common} = \frac{T {A}_{Common}}{2} , DCommonDrift = \frac{TACommonDrift}{2} , and DCommonDriftVariation = \frac{TACommonDriftVariation}{2} {Delay}_{common} ( t )$$

is the distance between the satellite 610 and the uplink time synchronization reference point divided by the speed of light. Downlink and uplink are frame aligned at the reference point with an offset given by N_{(TA,offset)}. N_{TA,common} is derived by the UE based on Delay_{common}(t) to pre-compensate the two-way transmission delay between the uplink time reference point and the satellite 610.

Example 600 shows such parameters as timing components in the NTN. For example, there may be a common TA for communications between the relay station 620 and the satellite 610. The timing between the UE 520 and the satellite 610 may include a TA (T_{TA}) plus Kmac, which may be made up of at least a general TA (K_{TA}), a UE-specific TA (K_{TA,UE-specific}), a common TA (K_{TA,common}), Koffset (K_{TA,offset}) and Kmac (K_{mac}). At least some of these timing elements are specific to NTNs.

Other parameters may include a cell stop time, disabled HARQ feedback, ephemeris information, and/or a polarization. A cell stop time may be a time during which a cell is valid for use and before satellite movement renders the cell invalid. Currently, broadcast of a cell stop time in a system information block (SIB) may only be applicable to quasi-earth fixed cell (not to a moving cell) and there is currently no information to address any moving cell-specific details associated with using the cell stop time to assist measurements or cell reselection. For a quasi-earth fixed cell, the broadcast timing information on when a cell is going to stop serving the area refers to the time when a cell stops covering the current area. In some aspects, if a cell stop time is broadcast via system information, a CG-SDT resource may become invalid after the broadcast cell stop time. Additionally, additional time offset information can be provided to the UE 520 in cell-specific or UE-specific manner. If provided, the UE 520 may not be allowed to attempt to transmit on the PUSCH with CG-SDT after the cell stop time minus the additional time offset received by the UE 520. An SIB may include a reduced bandwidth SIB (SIB-BR) for MTC devices or an NB SIB (NSIB) for NB IoT devices.

For a downlink HARQ process with disabled HARQ feedback, the UE 520 is not expected to receive another PDSCH or set of slot-aggregated PDSCH scheduled for the given HARQ process that starts until a time after the end of the reception of the last PDSCH or slot-aggregated PDSCH for that HARQ process. In some aspects, one or more of the CG-SDT HARQ process identifiers (IDs) can be HARQ feedback disabled, and the configuration may be UE-specific.

The network entity 510 may indicate polarization information for downlink and uplink. The polarization information for uplink may be indicated in an SIB. The UE 520 may assume a same polarization for uplink and downlink, when the uplink polarization information is absent. When polarization signaling is present in the SIB, the SIB may indicate downlink and/or uplink polarization information using respective polarization type parameters (e.g., RHCP, LHCP, or linear). Polarization signaling may be supported for a target serving cell in a handover command message, or for a non-serving cell in a radio resource management (RRM) measurement configuration. In some aspects, the network entity 510 may signal uplink and/or downlink polarization characteristics to the UE 520, and the configuration may be satellite and/or cell-specific (e.g., the UE 520 may obtain the information from system information).

The parameters may include ephemeris information, which is information that pertains to a trajectory of a satellite and/or astronomical objects. Other parameters may include a common TA (N_{TA,common}) and an epoch time (time based on a reference time) for transmission timing autonomous pre-compensation (open-loop timing adjustment). The parameters may include a validity duration configured by the network for satellite ephemeris data that indicates the maximum time during which the UE 520 can apply the satellite ephemeris without having acquired a new satellite ephemeris. The UE 520 may assume that the UE 520 has lost uplink synchronization if new or additional assistance information (i.e., serving satellite ephemeris data or common TA parameters) is not available within the associated validity duration. An NTN ephemeris validity timer should be started/restarted with a configured timer validity duration at the epoch time of the assistance information (i.e., serving satellite ephemeris data). A single validity duration for both serving satellite ephemeris and common TA related parameters may be defined at least if serving satellite ephemeris and common TA related parameters are signaled in the same SIB message. A single validity duration for both serving satellite ephemeris and common TA related parameters may be broadcast on the SIB. The UE 520 may read system information from the cell (satellite specific). If the validity duration expires, the UE 520 may read the system information before CG-SDT initial and subsequent transmissions.

The parameters may also include cell and/or satellite information. The availability of the UE-specific configured CG-SDT may not be limited to a single cell (i.e., can be made available in different cell(s) within the same satellite where the UE 520 was connected when the CG-SDT was configured or across satellites depending on the configuration). In this scenario, the UE 520 may be configured with a list of cells and/or satellites along with a set of CG-SDT parameters if an adjustment is to be made when the UE 520 moves to one of the cells in the list.

As indicated above, FIGS. 6 and 7 are provided as examples. Other examples may differ from what is described with respect to FIGS. 6 and 7.

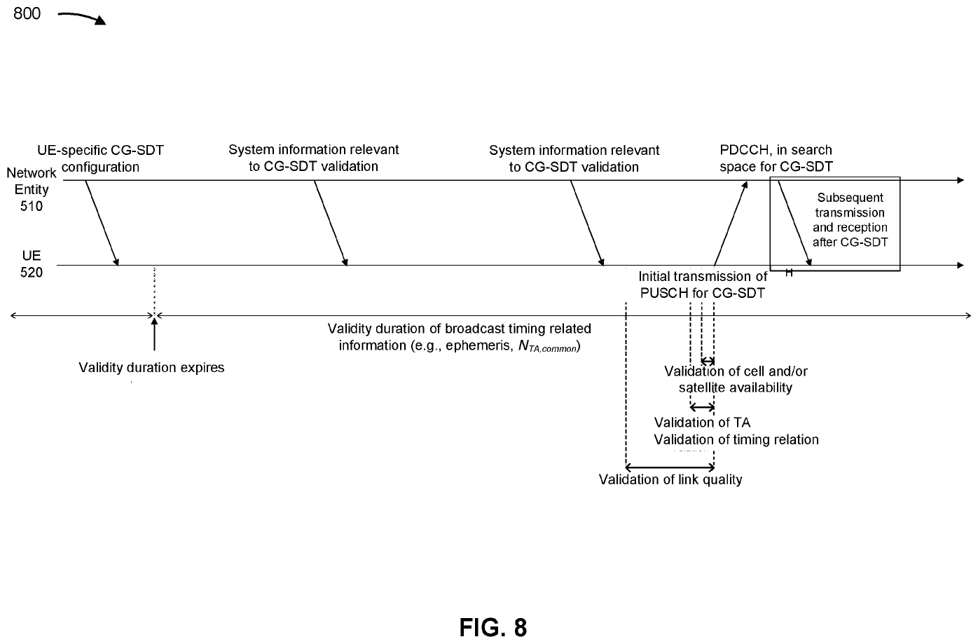

FIG. 8 is a diagram illustrating an example 800 of a timeline for providing a configuration and system information, in accordance with the present disclosure.

Example 800 shows that the network entity 510 (e.g., gNB) may transmit a UE-specific CG-SDT configuration and periodically transmit system information for validating parameters of the CG-SDT configuration. The UE-specific CG-SDT configuration may be for PUSCH and/or PUCCH configuration, may include a search space configuration for CG-SDT, and may include all or part of the validation criteria and parameters. The system information may include information relevant to CG-SDT validation in association with the validation criteria (e.g., ephemeris information, N_{TA,common}).

In some aspects, the UE 520 may fulfil the following four validation criteria, if configured, for uplink transmission of CG-SDT: validation of a TA, validation of a timing relation, validation of link quality, and validation of cell and/or satellite availability. For the subsequent transmissions after an initial transmission of CG-SDT, all or part of the criteria shall be still met.

For validation of the TA, in addition to legacy (terrestrial network) RSRP-based TA validation, some of the parameters may be involved, including ephemeris information, an N_{TA,common}, and an epoch time, for validating the TA. The UE 520 may receive the system information from the cell (e.g., satellite-specific). If the validity duration expires, the UE 520 may read the system information before CG-SDT initial and subsequent transmissions. Another parameter for validating the TA may include a UE position update. If the UE 520 is equipped with a global navigation satellite system (GNSS), the UE 520 may update its position based on a GNSS reading before transmitting in an RRC inactive state. If the UE 520 is not equipped with GNSS (e.g. NTN-IoT) and has to rely on a TA obtained from the network entity 510, and if the UE 520 is configured with a timer that allows the UF 520 to apply the same TA to uplink transmissions until the configured timer expires, the UE 520 may not use CG-SDT if the remaining time until the timer expires is less than or equal to A ms or B slots with respect to an SCS of a bandwidth part (BWP) configured for CG-SDT. A and/or B may be configured by the network entity 510 or hardcoded in stored configuration information (according to a standard). The UE 520 may reset and restart the timer when a timing advance command (TAC) is received, or if CG-SDT is reconfigured in an RRC inactive state (e.g., the timer gets extended).

The UE 520 may validate a timing relation using the system information. Validation of the timing relation may involve the Kmac and/or the Koffset, if configured and included in part of CG-SDT validation conditions, and may be maintained before uplink transmission for CG-SDT. If the Kmac is not included in part of validation condition, the Kmac may be separately signaled after an initial transmission of CG-SDT. For example, the UE 520 may receive a PDSCH communication, including the Kmac information, scheduled by a PDCCH communication in a CG-SDT search space.

The UE 520 may validate the link quality using the system information. An initial transmission on CG-SDT can be followed by PDCCH and PDSCH communications. Link quality validation for downlink reception RSRP thresholds (e.g., +/−RSRP-Threshold, RSRP thresholds used for TA validation in a terrestrial network) may be used for link quality validation. If an RSRP change with respect to a reference RSRP is more than a specified RSRP threshold, the UE 520 may not use CG-SDT. A reference point in time where the reference RSRP should be measured can be separately defined and different from that used for a terrestrial network (e.g., the reference RSRP is updated only when CG-SDT is configured or reconfigured).

The UE 520 may validate the link quality validation for an initial uplink transmission for CG-SDT and for subsequent transmissions (e.g., PUCCH and PUSCH communications). If an actual UE transmit power (e.g., combination of measured RSRP and power class (maximum transmit power)) is X decibels (dB) lesser than a specified or required transmit power (configured by the network entity 510), the UE 520 may not attempt to transmit for CG-SDT. X may be separately configured and/or hardcoded in stored configuration information for CG-SDT. Link quality validation may be applied to both RA-SDT and CG-SDT, but with what may be different threshold values. Link quality validation may also involve downlink and uplink polarization information.

The UE 520 may validate cell and/or satellite availability using the system information. This may include validating the cell stop time. If the cell stop time is broadcast via system information, the UE 520 may not use CG-SDT if the remaining time until the cell service stop time is less than or equal to Y ms or Z slots with respect to an SCS of a BWP configured for CG-SDT. Y and/or Z may be configured by the network entity 510 and/or hardcoded in stored configuration information. In some aspects, the cell stop time is restarted if the UE 520 receives the TA command or the timer is reconfigured by RRC dedicated signaling.

If a UE-specific configured CG-SDT can be used after cell (re)selection, the UE 520 may verify the above criteria for the newly (re)selected cell and/or satellite. If the newly (re)selected cell belongs to the same satellite as the cell that configured the CG-SDT, the UE 520 may skip part of the above criteria if the criteria are common between the cells.

Depending on the satellite type (e.g., GSO, NGSO) that the cell belongs to, part of the above criteria can be defined differently. For example, if the target cell belongs to a GSO satellite, the UE 520 may be exempt from updating the ephemeris information, and the N_{TA,common} may be exempt from a verification condition. Different verification criteria can be carried out in different time windows, including in terms of frequency of verification and starting/ending position for the verification before using a CG-SDT resource.

By using and validating parameters of a CG-SDT configuration that are for an NTN, the UE 520 and the network entity 510 may improve communications and conserve resources.

Example 800 also shows that an initial transmission of PUSCH CG-SDT by the UE 520 and a PDCCH communication (in a CG-SDT search space) from the network entity 510. The PDCCH communication may be for a new PUSCH transmission or a PUSCH retransmission. The PDCCH communication may be for a PDSCH communication or a PUCCH communication.

Example 800 also shows subsequent transmission and reception after CG-SDT. In some aspects, during subsequent transmissions after an initial transmission of CG-SDT, an uplink transmission timing requirement may be applied as if discontinuous reception (DRX) is in use. For example, the UE 520 may apply a gradual TA adjustment (e.g., as required) to the subsequent transmission. This is in contrast to an initial uplink transmission timing accuracy requirement that is currently applied to the initial transmission of CG-SDT.

If the UE 520 receives a TAC during subsequent transmissions, the UE 520 may apply a TA adjustment accuracy requirement to subsequent transmissions after a TA adjustment delay after the reception of the TAC. In some aspects, the UE 520 may maintain a TAC-based closed-loop TA during the subsequent transmissions after the reception of the TAC. The closed-loop TA may be reset in the next occasion of CG-SDT.

As indicated above, FIG. 8 is provided as an example. Other examples may differ from what is described with regard to FIG. 8.

FIG. 9 is a diagram illustrating an example process 900 performed, for example, by a UE, in accordance with the present disclosure. Example process 900 is an example where the UE (e.g., UE 520) performs operations associated with using a CG-SDT configuration for an NTN.

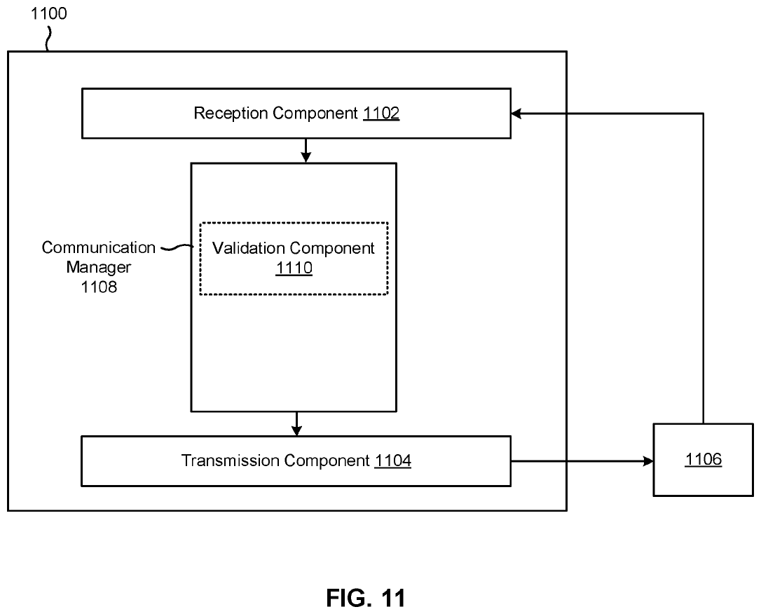

As shown in FIG. 9, in some aspects, process 900 may include receiving a UE-specific CG-SDT configuration with parameters specific to CG-SDT in an NTN (block 910). For example, the UE (e.g., using communication manager 1108 and/or reception component 1102 depicted in FIG. 11) may receive a UE-specific CG-SDT configuration with parameters specific to CG-SDT in an NTN, as described above.

As further shown in FIG. 9, in some aspects, process 900 may include receiving system information associated with validation of the parameters for CG-SDT on the NTN (block 920). For example, the UE (e.g., using communication manager 1108 and/or reception component 1102 depicted in FIG. 11) may receive system information associated with validation of the parameters for CG-SDT on the NTN, as described above.

As further shown in FIG. 9, in some aspects, process 900 may include transmitting an SDT to a network entity of the NTN using one or more of the parameters (block 930). For example, the UE (e.g., using communication manager 1108 and/or transmission component 1104 depicted in FIG. 11) may transmit an SDT to a network entity of the NTN using one or more of the parameters, as described above.

Process 900 may include additional aspects, such as any single aspect or any combination of aspects described below and/or in connection with one or more other processes described elsewhere herein.

In a first aspect, receiving the system information associated with CG-SDT validation includes receiving the system information associated with CG-SDT validation periodically.

In a second aspect, alone or in combination with the first aspect, the parameters include a MAC application TA Kmac for delaying an application of a downlink configuration indicated by a MAC CE.

In a third aspect, alone or in combination with one or more of the first and second aspects, the parameters include a time offset Koffset for delaying a RACH procedure initiated by a PDCCH communication and delaying uplink transmission scheduled by CG, and the time offset Koffset is specific to CG-SDT on the NTN.

In a fourth aspect, alone or in combination with one or more of the first through third aspects, the time offset Koffset is cell common.

In a fifth aspect, alone or in combination with one or more of the first through fourth aspects, the time offset Koffset is UE-specific.

In a sixth aspect, alone or in combination with one or more of the first through fifth aspects, the system information includes timing relation validation information for validating the MAC TA Kmac and the time offset Koffset, and process 900 includes validating the MAC TA Kmac and the time offset Koffset using the timing relation validation information.

In a seventh aspect, alone or in combination with one or more of the first through sixth aspects, the parameters include ephemeris information and a common TA.

In an eighth aspect, alone or in combination with one or more of the first through seventh aspects, the system information includes TA validation information for validating the ephemeris information or the common TA, and process 900 includes validating the ephemeris information or the common TA using the TA validation information.

In a ninth aspect, alone or in combination with one or more of the first through eighth aspects, validating the ephemeris information or the common TA includes using the TA validation information includes using the TA validation information to validate an epoch time or a validity duration of the ephemeris information or the common TA for CG-SDT based at least in part on one or more of a location of the UE or a timer.

In a tenth aspect, alone or in combination with one or more of the first through ninth aspects, the parameters include a parameter to disable a HARQ CG-SDT process on the NTN.

In an eleventh aspect, alone or in combination with one or more of the first through tenth aspects, the parameters include a polarization parameter for CG-SDT on the NTN.

In a twelfth aspect, alone or in combination with one or more of the first through eleventh aspects, process 900 includes receiving an indication of a time offset that is cell-specific or UE-specific, and the parameters include a cell stop time during which a serving cell is valid for CG-SDT on the NTN, and the UE is restricted from transmitting a CG-SDT on the NTN after an end of the cell stop time minus the time offset.

In a thirteenth aspect, alone or in combination with one or more of the first through twelfth aspects, the parameters include a cell parameter configured for CG-SDT on the NTN or a satellite parameter configured for CG-SDT on the NTN.

In a fourteenth aspect, alone or in combination with one or more of the first through thirteenth aspects, the system information includes TA validation information specific to CG-SDT, and process 900 includes validating a TA for CG-SDT on the NTN using the TA validation information.

In a fifteenth aspect, alone or in combination with one or more of the first through fourteenth aspects, the system information includes link quality validation information for validating a link quality for CG-SDT on the NTN, and process 900 includes validating the link quality for CG-SDT on the NTN using the link quality validation information.

In a sixteenth aspect, alone or in combination with one or more of the first through fifteenth aspects, validating the link quality for CG-SDT on the NTN includes validating the link quality for CG-SDT on the NTN using a measurement threshold for CG-SDT that has a measurement duration that is different than a measurement duration for a measurement threshold for CG-SDT on a terrestrial network or a power class threshold for CG-SDT on the NTN that is different than a power class threshold for CG-SDT on the terrestrial network.

In a seventeenth aspect, alone or in combination with one or more of the first through sixteenth aspects, the system information includes cell or satellite validation information for validating a cell or satellite for CG-SDT, and process 900 includes validating the cell or satellite for CG-SDT using the cell or satellite validation information.

In an eighteenth aspect, alone or in combination with one or more of the first through seventeenth aspects, validating the cell or satellite for CG-SDT includes validating a cell stop time during which a serving cell is valid for CG-SDT on the NTN using the cell or satellite validation information.

In a nineteenth aspect, alone or in combination with one or more of the first through eighteenth aspects, process 900 includes skipping validation of the parameters for CG-SDT on the NTN based at least in part on the CG-SDT configuration.

In a twentieth aspect, alone or in combination with one or more of the first through nineteenth aspects, further comprising, after the transmitting of the SDT, applying a timing advance adjustment to a subsequent uplink transmission.

In a twenty-first aspect, alone or in combination with one or more of the first through twentieth aspects, process 900 includes receiving a TAC, maintaining a TAC-based closed-loop timing advance during subsequent uplink transmissions, and resetting the closed-loop timing advance in a next transmission occasion of CG-SDT on the NTN.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network entity, in accordance with the present disclosure. Example process 1000 is an example where the network entity (e.g., network entity 510) performs operations associated with transmitting a CG-SDT configuration for an NTN.

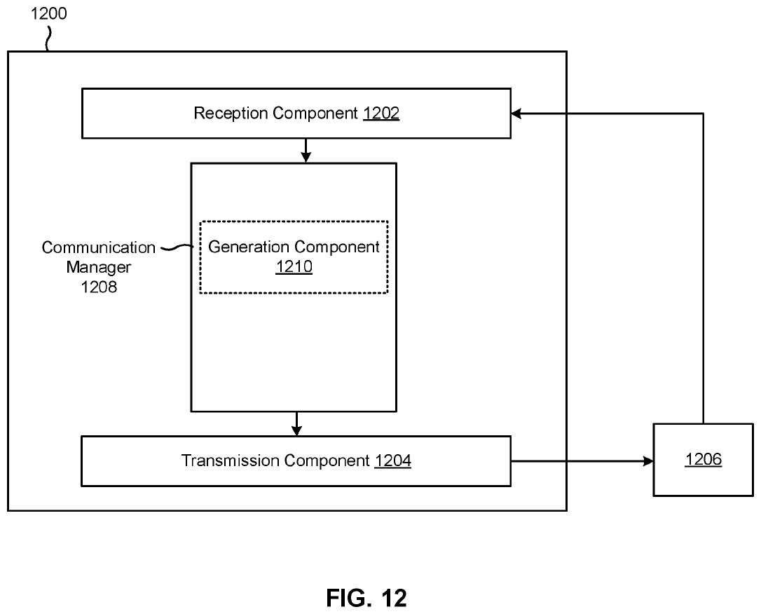

As shown in FIG. 10, in some aspects, process 1000 may include transmitting a UE-specific CG-SDT configuration with parameters specific to CG-SDT in the NTN (block 1010). For example, the network entity (e.g., using communication manager 1208 and/or transmission component 1204 depicted in FIG. 12) may transmit a UE-specific CG-SDT configuration with parameters specific to CG-SDT in the NTN, as described above.

As further shown in FIG. 10, in some aspects, process 1000 may include transmitting system information associated with validation of the parameters for CG-SDT on the NTN (block 1020). For example, the network entity (e.g., using communication manager 1208 and/or transmission component 1204 depicted in FIG. 12) may transmit system information associated with validation of the parameters for CG-SDT on the NTN, as described above.

As further shown in FIG. 10, in some aspects, process 1000 may include receiving an SDT based at least in part on one or more of the parameters (block 1030). For example, the network entity (e.g., using communication manager 1208 and/or reception component 1202 depicted in FIG. 12) may receive an SDT based at least in part on one or more of the parameters, as described above.

Process 1000 may include additional aspects, such as any single aspect or any combination of aspects described below and/or in connection with one or more other processes described elsewhere herein.

In a first aspect, the parameters include a MAC application timing advance (TA) Kmac for delaying an application of a downlink configuration indicated by a MAC CE.

In a second aspect, alone or in combination with the first aspect, the parameters include a time offset Koffset for delaying a random access procedure initiated by a physical downlink control channel communication and delaying uplink transmission scheduled by CG, and the time offset Koffset is specific to CG-SDT on the NTN.

In a third aspect, alone or in combination with one or more of the first and second aspects, the system information includes timing relation validation information for validating the MAC TA Kmac and the time offset Koffset.

In a fourth aspect, alone or in combination with one or more of the first through third aspects, the parameters include ephemeris information and a common TA, and the system information includes TA validation information for validating a validity duration of the ephemeris information or the common TA.

In a fifth aspect, alone or in combination with one or more of the first through fourth aspects, the system information includes one or more of TA validation information specific to CG-SDT, link quality validation information for validating a link quality for CG-SDT on the NTN, or cell or satellite validation information for validating a cell or satellite for CG-SDT.

In a sixth aspect, alone or in combination with one or more of the first through fifth aspects, further comprising, after the receiving of the SDT, receiving a subsequent uplink transmission with a TA adjustment.

In a seventh aspect, alone or in combination with one or more of the first through sixth aspects, process 1000 includes transmitting a TAC, maintaining a TAC-based closed-loop timing advance during subsequent uplink transmissions, and resetting the closed-loop timing advance in a next transmission occasion of CG-SDT on the NTN.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication. The apparatus 1100 may be a UE (e.g., UE 520), or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 1108. The communication manager 1108 may control and/or otherwise manage one or more operations of the reception component 1102 and/or the transmission component 1104. In some aspects, the communication manager 1108 may include one or more antennas, a modem, a controller/processor, a memory, or a combination thereof, of the UE 120 described in connection with FIG. 2. The communication manager 1108 may be, or be similar to, the communication manager 150 depicted in FIGS. 1 and 2. For example, in some aspects, the communication manager 1108 may be configured to perform one or more of the functions described as being performed by the communication manager 150. In some aspects, the communication manager 1108 may include the reception component 1102 and/or the transmission component 1104. The communication manager 1108 may include a validation component 1110, among other examples.

In some aspects, the apparatus 1100 may be configured to perform one or more operations described herein in connection with FIGS. 1-8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The reception component 1102 may receive a UE-specific CG-SDT configuration with parameters specific to CG-SDT in an NTN. The reception component 1102 may receive system information associated with validation of the parameters for CG-SDT on the NTN. The transmission component 1104 may transmit an SDT to a network entity of the NTN using one or more of the parameters.

The reception component 1102 may receive an indication of a time offset that is cell-specific or UE-specific, the parameters may include a cell stop time during which a serving cell is valid for CG-SDT on the NTN, and the UE may be restricted from transmitting a CG-SDT on the NTN after an end of the cell stop time minus the time offset.

The validation component 1110 may skip validation of the parameters for CG-SDT on the NTN based at least in part on the CG-SDT configuration.

The reception component 1102 may receive a TAC. The transmission component 1104 may maintain a TAC-based closed-loop timing advance during subsequent uplink transmissions. The transmission component 1104 may reset the closed-loop timing advance in a next transmission occasion of CG-SDT on the NTN.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication. The apparatus 1200 may be a network entity (e.g., network entity 510), or a network entity may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 1208. The communication manager 1208 may control and/or otherwise manage one or more operations of the reception component 1202 and/or the transmission component 1204. In some aspects, the communication manager 1208 may include one or more antennas, a modem, a controller/processor, a memory, or a combination thereof, of the network entity described in connection with FIG. 2. The communication manager 1208 may be, or be similar to, the communication manager 150 depicted in FIGS. 1 and 2. For example, in some aspects, the communication manager 1208 may be configured to perform one or more of the functions described as being performed by the communication manager 150. In some aspects, the communication manager 1208 may include the reception component 1202 and/or the transmission component 1204. The communication manager 1208 may include a generation component 1210, among other examples.

In some aspects, the apparatus 1200 may be configured to perform one or more operations described herein in connection with FIGS. 1-8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the network entity described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network entity described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the network entity described in connection with FIG. 2. In some aspects, the transmission component 1204 may be co-located with the reception component 1202 in a transceiver.

The generation component 1210 may generate a UE-specific CG-SDT configuration with parameters specific to CG-SDT in the NTN. The transmission component 1204 may transmit the CG-SDT configuration for NTN. The transmission component 1204 may transmit system information associated with validation of the parameters for CG-SDT on the NTN. The reception component 1202 may receive an SDT based at least in part on one or more of the parameters.

The transmission component 1204 may transmit a TAC. The reception component 1202 may maintain a TAC-based closed-loop timing advance during subsequent uplink transmissions. The reception component 1202 may reset the closed-loop timing advance in a next transmission occasion of CG-SDT on the NTN.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: receiving a UE-specific configured grant (CG) small data transmission (SDT) configuration with parameters specific to CG-SDT in a non-terrestrial network (NTN); receiving system information associated with validation of the parameters for CG-SDT on the NTN; and transmitting an SDT to a network entity of the NTN using one or more of the parameters.

Aspect 2: The method of Aspect 1, wherein receiving the system information associated with CG-SDT validation includes receiving the system information associated with CG-SDT validation periodically.

Aspect 3: The method of Aspect 1 or 2, wherein the parameters include a medium access control (MAC) application timing advance (TA) Kmac for delaying an application of a downlink configuration indicated by a MAC control element (MAC CE).

Aspect 4: The method of Aspect 3, wherein the parameters include a time offset Koffset for delaying a random access procedure initiated by a physical downlink control channel communication and delaying uplink transmission scheduled by CG, and wherein the time offset Koffset is specific to CG-SDT on the NTN.

Aspect 5: The method of Aspect 4, wherein the time offset Koffset is cell common.

Aspect 6: The method of Aspect 4, wherein the time offset Koffset is UE-specific.

Aspect 7: The method of Aspect 6, wherein the time offset Koffset is configured while the UE is in a radio resource control connected mode.

Aspect 8: The method of Aspect 6, wherein the time offset Koffset is a separate UE-specific Koffset for CG-SDT that is configured in a radio resource control release message.

Aspect 9: The method of Aspect 6, wherein the time offset Koffset is reconfigured in a radio resource control inactive mode.

Aspect 10: The method of any of Aspects 4-9, wherein the system information includes timing relation validation information for validating the MAC TA Kmac and the time offset Koffset, and wherein the method further includes validating the MAC TA Kmac and the time offset Koffset using the timing relation validation information.

Aspect 11: The method of Aspect 3, wherein the MAC TA Kmac is received in a separate message in a CG-SDT search space.

Aspect 12: The method of any of Aspects 1-11, wherein the parameters include ephemeris information and a common timing advance (TA).

Aspect 13: The method of Aspect 12, wherein the system information includes TA validation information for validating the ephemeris information or the common TA, and wherein the method further includes validating the ephemeris information or the common TA using the TA validation information.

Aspect 14: The method of Aspect 13, wherein validating the ephemeris information or the common TA includes using the TA validation information includes using the TA validation information to validate an epoch time or a validity duration of the ephemeris information or the common TA for CG-SDT based at least in part on one or more of a location of the UE or a timer.

Aspect 15: The method of any of Aspects 1-14, wherein the parameters include a parameter to disable a hybrid automatic repeat request CG-SDT process on the NTN.

Aspect 16: The method of any of Aspects 1-15, wherein the parameters include a polarization parameter for CG-SDT on the NTN.

Aspect 17: The method of any of Aspects 1-16, further comprising receiving an indication of a time offset that is cell-specific or UE-specific, and wherein the parameters include a cell stop time during which a serving cell is valid for CG-SDT on the NTN, and the UE is restricted from transmitting a CG-SDT on the NTN after an end of the cell stop time minus the time offset.

Aspect 18: The method of any of Aspects 1-17, wherein the parameters include a cell parameter configured for CG-SDT on the NTN or a satellite parameter configured for CG-SDT on the NTN.

Aspect 19: The method of any of Aspects 1-18, wherein the parameters include a set of CG-SDT parameters associated with a configured list of cells.

Aspect 20: The method of any of Aspects 1-19, wherein the parameters include a set of CG-SDT parameters associated with a configured list of satellites.

Aspect 21: The method of any of Aspects 1-20, wherein the system information includes timing advance (TA) validation information specific to CG-SDT, and wherein the method further includes validating a TA for CG-SDT on the NTN using the TA validation information.

Aspect 22: The method of any of Aspects 1-21, wherein the UE uses CG-SDT based at least in part on expiration of a timer associated with a timing advance.

Aspect 23: The method of any of Aspects 1-22, wherein the system information includes link quality validation information for validating a link quality for CG-SDT on the NTN, and wherein the method further includes validating the link quality for CG-SDT on the NTN using the link quality validation information.

Aspect 24: The method of Aspect 23, wherein validating the link quality for CG-SDT on the NTN includes validating the link quality for CG-SDT on the NTN using a measurement threshold for CG-SDT that has a measurement duration that is different than a measurement duration for a measurement threshold for CG-SDT on a terrestrial network or a power class threshold for CG-SDT on the NTN that is different than a power class threshold for CG-SDT on the terrestrial network.

Aspect 25: The method of any of Aspects 1-24, wherein the system information includes cell or satellite validation information for validating a cell or satellite for CG-SDT, and wherein the method includes validating the cell or satellite for CG-SDT using the cell or satellite validation information.

Aspect 26: The method of Aspect 25, wherein validating the cell or satellite for CG-SDT includes validating a cell stop time during which a serving cell is valid for CG-SDT on the NTN using the cell or satellite validation information.

Aspect 27: The method of Aspect 26, wherein the cell stop time is restarted if the UE receives a timing advance command or a timer is reconfigured by radio resource control dedicated signaling.

Aspect 28: The method of any of Aspects 1-27, further comprising skipping validation of the parameters for CG-SDT on the NTN based at least in part on the CG-SDT configuration.

Aspect 29: The method of any of Aspects 1-28, wherein the one or more processors are configured to skip validation of the parameters for CG-SDT on the NTN based at least in part on a newly reselected cell belonging to a same satellite as a previous cell and having common criteria with the previous cell.

Aspect 30: The method of any of Aspects 1-29, wherein the one or more processors are configured to skip validation of the parameters for CG-SDT on the NTN based at least in part on a satellite type associated with a cell.

Aspect 31: The method of any of Aspects 1-30, wherein the one or more processors are configured to perform validation of the parameters for CG-SDT on the NTN within one or more time windows.

Aspect 32: The method of any of Aspects 1-31, further comprising, after the transmitting of the SDT, applying a timing advance adjustment to a subsequent uplink transmission.

Aspect 33: The method of any of Aspects 1-32, further comprising: receiving a timing advance command (TAC); maintaining a TAC-based closed-loop timing advance during subsequent uplink transmissions; and resetting the closed-loop timing advance in a next transmission occasion of CG-SDT on the NTN.

Aspect 34: A method of wireless communication performed by a network entity of a non-terrestrial network (NTN), comprising: transmitting a user equipment (UE)-specific configured grant (CG) small data transmission (SDT) configuration with parameters specific to CG-SDT in the NTN; transmitting system information associated with validation of the parameters for CG-SDT on the NTN; and receiving an SDT based at least in part on one or more of the parameters.

Aspect 35: The method of Aspect 34, wherein the parameters include a medium access control (MAC) application timing advance (TA) Kmac for delaying an application of a downlink configuration indicated by a MAC control element (MAC CE).

Aspect 36: The method of Aspect 35, wherein the parameters include a time offset Koffset for delaying a random access procedure initiated by a physical downlink control channel communication and delaying uplink transmission scheduled by CG, and wherein the time offset Koffset is specific to CG-SDT on the NTN.

Aspect 37: The method of Aspect 36, wherein the system information includes timing relation validation information for validating the MAC TA Kmac and the time offset Koffset.

Aspect 38: The method of any of Aspects 34-37, wherein the parameters include ephemeris information and a common timing advance (TA), and wherein the system information includes TA validation information for validating a validity duration of the ephemeris information or the common TA.

Aspect 39: The method of any of Aspects 34-38, wherein the system information includes one or more of timing advance (TA) validation information specific to CG-SDT, link quality validation information for validating a link quality for CG-SDT on the NTN, or cell or satellite validation information for validating a cell or satellite for CG-SDT.

Aspect 40: The method of any of Aspects 34-39, further comprising, after the receiving of the SDT, receiving a subsequent uplink transmission with a timing advance adjustment.

Aspect 41: The method of any of Aspects 34-40, further comprising: transmitting a timing advance command (TAC); maintaining a TAC-based closed-loop timing advance during subsequent uplink transmissions; and resetting the closed-loop timing advance in a next transmission occasion of CG-SDT on the NTN.

Aspect 42: An apparatus for wireless communication at a device, comprising a processor; memory coupled with the processor; and instructions stored in the memory and executable by the processor to cause the apparatus to perform the method of one or more of Aspects 1-41.

Aspect 43: A device for wireless communication, comprising a memory and one or more processors coupled to the memory, the one or more processors configured to perform the method of one or more of Aspects 1-41.

Aspect 44: An apparatus for wireless communication, comprising at least one means for performing the method of one or more of Aspects 1-41.

Aspect 45: A non-transitory computer-readable medium storing code for wireless communication, the code comprising instructions executable by a processor to perform the method of one or more of Aspects 1-41.

Aspect 46: A non-transitory computer-readable medium storing a set of instructions for wireless communication, the set of instructions comprising one or more instructions that, when executed by one or more processors of a device, cause the device to perform the method of one or more of Aspects 1-41.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based. at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors, coupled to the memory, configured to:
receive a UE-specific configured grant (CG) small data transmission (SDT) configuration with parameters specific to CG-SDT in a non-terrestrial network (NTN);
receive system information associated with validation of the parameters for CG-SDT on the NTN; and
transmit an SDT to a network entity of the NTN using one or more of the parameters.

2. The UE of claim 1, wherein the one or more processors, to receive the system information associated with CG-SDT validation, are configured to receive the system information associated with CG-SDT validation periodically.

3. The UE of claim 1, wherein the parameters include a medium access control (MAC) application timing advance (TA) Kmac for delaying an application of a downlink configuration indicated by a MAC control element (MAC CE).

4. The UE of claim 3, wherein the parameters include a time offset Koffset for delaying a random access procedure initiated by a physical downlink control channel communication and delaying uplink transmission scheduled by CG, and wherein the time offset Koffset is specific to CG-SDT on the NTN.

5. The UE of claim 4, wherein the time offset Koffset is cell common.

6. The UE of claim 4, wherein the time offset Koffset is UE-specific.

7. The UE of claim 6, wherein the time offset Koffset is configured while the UE is in a radio resource control connected mode.

8. The UE of claim 6, wherein the time offset Koffset is a separate UE-specific Koffset for CG-SDT that is configured in a radio resource control release message.

9. The UE of claim 6, wherein the time offset Koffset is reconfigured in a radio resource control inactive mode.

10. The UE of claim 4, wherein the system information includes timing relation validation information for validating the MAC TA Kmac and the time offset Koffset, and wherein the one or more processors are configured to validate the MAC TA Kmac and the time offset Koffset using the timing relation validation information.

11. The UE of claim 3, wherein the MAC TA Kmac is received in a separate message in a CG-SDT search space.

12. The UE of claim 1, wherein the parameters include ephemeris information and a common timing advance (TA).

13. The UE of claim 12, wherein the system information includes TA validation information for validating the ephemeris information or the common TA, and wherein the one or more processors are configured to validate the ephemeris information or the common TA using the TA validation information.

14. The UE of claim 13, wherein the one or more processors, to validate the ephemeris information or the common TA, are configured to use the TA validation information includes using the TA validation information to validate an epoch time or a validity duration of the ephemeris information or the common TA for CG-SDT based at least in part on one or more of a location of the UE or a timer.

15. The UE of claim 1, wherein the parameters include a parameter to disable a hybrid automatic repeat request CG-SDT process on the NTN.

16. The UE of claim 1, wherein the parameters include a polarization parameter for CG-SDT on the NTN.

17. The UE of claim 1, wherein the one or more processors are configured to receive an indication of a time offset that is cell-specific or UE-specific, and wherein the parameters include a cell stop time during which a serving cell is valid for CG-SDT on the NTN, and the UE is restricted from transmitting a CG-SDT on the NTN after an end of the cell stop time minus the time offset.

18. The UE of claim 1, wherein the parameters include a cell parameter configured for CG-SDT on the NTN or a satellite parameter configured for CG-SDT on the NTN.

19. The UE of claim 1, wherein the parameters include a set of CG-SDT parameters associated with a configured list of cells.

20. The UE of claim 1, wherein the parameters include a set of CG-SDT parameters associated with a configured list of satellites.

21. The UE of claim 1, wherein the system information includes timing advance (TA) validation information specific to CG-SDT, and wherein the one or more processors are configured to validate a TA for CG-SDT on the NTN using the TA validation information.

22. The UE of claim 1, wherein the UE uses CG-SDT based at least in part on expiration of a timer associated with a timing advance.

23. The UE of claim 1, wherein the system information includes link quality validation information for validating a link quality for CG-SDT on the NTN, and wherein the one or more processors are configured to validate the link quality for CG-SDT on the NTN using the link quality validation information.

24. The UE of claim 23, wherein the one or more processors, to validate the link quality for CG-SDT on the NTN, are configured to validate the link quality for CG-SDT on the NTN using a measurement threshold for CG-SDT that has a measurement duration that is different than a measurement duration for a measurement threshold for CG-SDT on a terrestrial network or a power class threshold for CG-SDT on the NTN that is different than a power class threshold for CG-SDT on the terrestrial network.

25. The UE of claim 1, wherein the system information includes cell or satellite validation information for validating a cell or satellite for CG-SDT, and wherein the one or more processors are configured to validate the cell or satellite for CG-SDT using the cell or satellite validation information.

26. The UE of claim 25, wherein the one or more processors, to validate the cell or satellite for CG-SDT, are configured to validate a cell stop time during which a serving cell is valid for CG-SDT on the NTN using the cell or satellite validation information.

27. The UE of claim 26, wherein the cell stop time is restarted if the UE receives a timing advance command or a timer is reconfigured by radio resource control dedicated signaling.

28. The UE of claim 1, wherein the one or more processors are configured to skip validation of the parameters for CG-SDT on the NTN based at least in part on the CG-SDT configuration.

29. The UE of claim 1, wherein the one or more processors are configured to skip validation of the parameters for CG-SDT on the NTN based at least in part on a newly reselected cell belonging to a same satellite as a previous cell and having common criteria with the previous cell.

30. The UE of claim 1, wherein the one or more processors are configured to skip validation of the parameters for CG-SDT on the NTN based at least in part on a satellite type associated with a cell.

31. The UE of claim 1, wherein the one or more processors are configured to perform validation of the parameters for CG-SDT on the NTN within one or more time windows.

32. The UE of claim 1, wherein the one or more processors are configured to, after transmission of the SDT, apply a timing advance adjustment to a subsequent uplink transmission.

33. The UE of claim 1, wherein the one or more processors are configured to:
receive a timing advance command (TAC);
maintain a TAC-based closed-loop timing advance during subsequent uplink transmissions; and
reset the closed-loop timing advance in a next transmission occasion of CG-SDT on the NTN.

34. A network entity in a non-terrestrial network (NTN) for wireless communication, comprising:
a memory; and
one or more processors, coupled to the memory, configured to:
transmit a user equipment (UE)-specific configured grant (CG) small data transmission (SDT) configuration with parameters specific to CG-SDT in the NTN;
transmit system information associated with validation of the parameters for CG-SDT on the NTN; and
receive an SDT based at least in part on one or more of the parameters.

35. The network entity of claim 34, wherein the parameters include a medium access control (MAC) application timing advance (TA) Kmac for delaying an application of a downlink configuration indicated by a MAC control element (MAC CE).

36. The network entity of claim 35, wherein the parameters include a time offset Koffset for delaying a random access procedure initiated by a physical downlink control channel communication and delaying uplink transmission scheduled by CG, and wherein the time offset Koffset is specific to CG-SDT on the NTN.

37. The network entity of claim 36, wherein the system information includes timing relation validation information for validating the MAC TA Kmac and the time offset Koffset.

38. The network entity of claim 34, wherein the parameters include ephemeris information and a common timing advance (TA), and wherein the system information includes TA validation information for validating a validity duration of the ephemeris information or the common TA.

39. The network entity of claim 34, wherein the system information includes one or more of timing advance (TA) validation information specific to CG-SDT, link quality validation information for validating a link quality for CG-SDT on the NTN, or cell or satellite validation information for validating a cell or satellite for CG-SDT.

40. The network entity of claim 34, wherein the one or more processors are configured to, after reception of the SDT, receive a subsequent uplink transmission with a timing advance adjustment.

41. The network entity of claim 34, wherein the one or more processors are configured to:
transmit a timing advance command (TAC);
maintain a TAC-based closed-loop timing advance during subsequent uplink transmissions; and
reset the closed-loop timing advance in a next transmission occasion of CG-SDT on the NTN.

42. A method of wireless communication performed by a user equipment (UE), comprising:
receiving a UE-specific configured grant (CG) small data transmission (SDT) configuration with parameters specific to CG-SDT in a non-terrestrial network (NTN);
receiving system information associated with validation of the parameters for CG-SDT on the NTN; and
transmitting an SDT to a network entity of the NTN using one or more of the parameters.

43.-50. (canceled)

51. A method of wireless communication performed by a network entity in a non-terrestrial network (NTN), comprising:
transmitting a user equipment (UE)-specific configured grant (CG) small data transmission (SDT) configuration with parameters specific to CG-SDT in the NTN;
transmitting system information associated with validation of the parameters for CG-SDT on the NTN; and
receiving an SDT based at least in part on one or more of the parameters.

52.-55. (canceled)
